(19) United States
(12) Patent Application Publication
(10) Pub. No.: US 2009/0208123 A1
(43) Pub. Date: Aug. 20, 2009

(54) ENHANCED VIDEO PROCESSING USING MOTION VECTOR DATA

(75) Inventor: Daniel Doswald, Munich (DE)

Correspondence Address: MCANDREWS HELD & MALLOY, LTD, 500 WEST MADISON STREET, SUITE 3400, CHICAGO, IL, 60661, US

(73) Assignee: Advanced Micro Devices, Inc., Sunnyvale, CA (US)

(21) Appl. No.: 12/032,796

(22) Filed: Feb. 18, 2008

(51) Int. Cl. G06K 9/36

(52) U.S. Cl. 382/236

(57) ABSTRACT

A device and method for interpolation during frame rate conversion are disclosed. The method includes, receiving original frames Fₙ and Fₙ₊₁ to interpolate a new frame Fₚ between the original frames. The method involves forming candidate motion vectors describing possible motion trajectories for groups of pixels between Fₙ and Fₙ₊₁ respectively, and selecting actual motion vectors from the candidate vectors. Each motion vector is selected with respect to a group of pixel locations in the new frame Fₚ to be interpolated. The device includes a motion estimator, an interpolator and a correction engine. Motion vectors are computed by the estimator, while the new frame is interpolated by the interpolator using motion compensated interpolation. The motion vectors are further used to identify regions of halo artifacts in the interpolated frame and filtering is applied by the correction engine to reduce the halo artifacts.

### FIELD OF THE INVENTION

The present invention relates generally to video processing, and more particularly to frame rate conversion.

### BACKGROUND OF THE INVENTION

Video is typically recorded or encoded at a predetermined frame rate. For example, cinema films are typically recorded at a fixed rate of 24 frames per second (fps). On the other hand, in North America, video broadcast for television conforming to the NTSC standard, is encoded at 30 fps. Video broadcast in accordance with European PAL or SECAM standards is encoded at 25 fps.

Conversion between frame rates has created challenges. One common technique of converting frame rates involves dropping or repeating frames within a frame sequence. For example, telecine conversion (often referred to as 3:2 pull down) is used to convert 24 fps motion picture video to 60 fields per second (30 fps). Each second frame spans 3 fields, while each other second frame spans two fields. Telecine conversion is, for example, detailed in Charles Poynton, Digital Video and HDTV Algorithms and Interfaces, (San Francisco: Morgan Kaufmann Publishers, 2003), the contents of which are hereby incorporated by reference.

Various other techniques for frame rate conversion are discussed in John Watkinson “The Engineer's Guide to Standards Conversion”, Snell and Wilcox Handbook Series and “The Engineer's Guide to Motion Compensation”, Snell and Wilcox Handbook Series.

More recently, frame rate conversion has not only been used for conversion between standards, but also to enhance overall video quality. For example, in an effort to reduce perceptible flicker associate with conventional PAL televisions, high frame rate 100 field per second (50 fps) televisions have become available.

In the future, higher frame rates may become a significant component in providing higher quality home video. Existing video, however, is not readily available at these higher frame rates. Accordingly, frame rate conversion will be necessary. Such conversion, in real time presents numerous challenges.

To avoid artifacts such as jerking motions introduced when simple algorithms such as repeating frames are used in frame rate conversion, frames may be interpolated to form motion interpolated frames introduced during frame rate conversion.

Interpolated frames can be performed by estimating the motion of objects represented as groups of pixels, and interpolating along the direction of motion of the objects. However, as objects may move to expose or occlude other objects or background, artifacts may be created near object boundaries. Such artifacts are known as halos.

Accordingly, there is a need for improved frame rate conversion techniques and to reduce artifacts that may be introduced in interpolated frames or fields.

### SUMMARY OF THE INVENTION

In accordance with one aspect of the present invention, there is provided a method of interpolation for frame rate conversion. The method includes, using original frames Fₙ and Fₙ₊₁, to form an intermediate frame Fₚ between Fₙ and Fₙ₊₁. The method also includes partitioning Fₙ and Fₙ₊₁ into groups of pixels and forming candidate vectors. Each of the candidate vectors connects a group in Fₙ to a corresponding group in Fₙ₊₁. The method includes forming a set of motion vectors by forming groups of pixel locations in Fₚ; and for each one of the groups of pixel locations Bₚ in Fₚ, selecting a motion vector from the candidate vectors, each arranged to pass through Bₚ. The method also includes interpolating pixel values of the pixel locations in Bₚ from at least one group in Fₙ and Fₙ₊₁ associated with the selected motion vector; and identifying regions of halo artifacts in the new frame Fₚ using the motion vectors and filtering the regions to reduce the halo artifacts.

In accordance with another aspect of the present invention, there is provided a frame rate converter circuit including a motion vector estimator, an interpolator and a correction engine. The motion vector estimator is in communication with a buffer. The estimator forms candidate vectors each connecting a group of pixels in Fₙ to a corresponding group of pixels in Fₙ₊₁, where Fₙ and Fₙ₊₁ are original frames. The estimator forms groups of pixel locations in Fₚ and forms a set of motion vectors by selecting a motion vector for each of the groups Bₚ in Fₚ from the candidate vectors, with each candidate vector arranged to pass through Bₚ. The interpolator is in communication with the estimator, and provides an interpolated frame Fₚ between Fₙ and Fₙ₊₁, by interpolating pixel values of the locations in Bₚ from at least one of a first and second group of pixels in Fₙ and Fₙ₊₁ respectively, connected by the selected motion vector. The correction engine performs halo artifact correction on Fₚ using the set of motion vectors.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of the present invention,

FIG. 1 is a logical spatiotemporal diagram of a sequence of original and interpolated frames;

FIG. 2 is a logical plan view of a subset of the frames depicted in FIG. 1 depicting possible motion trajectories;

FIG. 3 is a flowchart depicting steps taken in a conventional method for motion compensated interpolation of a frame;

FIG. 4 is a schematic diagram of a video device, exemplary of the present invention, for interpolating new frames during frame rate conversion;

FIG. 5 is a flowchart of an exemplary operation of the video device of FIG. 4; and

FIG. 6 is another logical spatiotemporal diagram illustrating motion compensated interpolation, exemplary of an embodiment of the present invention.

### DETAILED DESCRIPTION

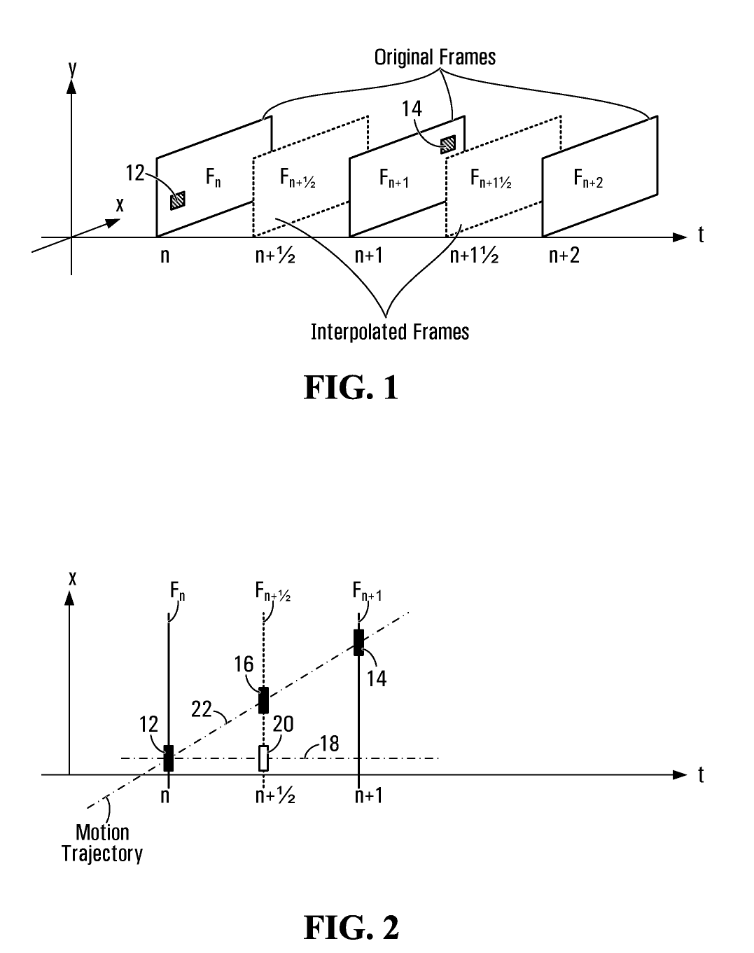

FIG. 1 illustrates a sequence of frames Fₙ, Fₙ₊₁, Fₙ₊₂ depicted in time in a spatiotemporal diagram, at time instants t=n, t=n+1, t=n+2 respectively. In addition, interpolated frames F_{n+1/2} and F_{n+1 1/2} are also depicted using dashed outlines. The vertical spatial axis is denoted y, while the horizontal side of each frame extends along the horizontal spatial axis denoted x. The time axis, denoted t, logically depicts time instants n, n+1, n+2 . . . etc.

A group of pixels 12 representing an object are depicted near the left side of frame Fₙ. Another group of pixels 14 in frame Fₙ₊₁, representing the same object, is shown closer to the right side of the frame as a result of its motion in between time instants t=n and t=n+1.

FIG. 2 depicts a logical plan view of the frames Fₙ, Fₙ₊₁ and interpolated frame F_{n+1 1/2}, which are a subset of the frames depicted in FIG. 1. The object represented by pixels 12, when interpolated using motion trajectory 22 is represented by pixels 16 in interpolated frame F_{n+1/2}. The same object would be represented by pixels 20, when using an alternate trajectory 18, corresponding to no motion, is used (resulting for example, from frame repetition).

As can be appreciated, if frame Fₙ is simply repeated to form frame F_{n+1/2}, then the placement of pixels 20 (corresponding pixels 12 in Fₙ), would be incorrect as it fails to account for the true motion of the object represented by pixels 12. This results in jerky motion, with motion only observable after the interpolated frames F_{n+1/2}, F_{n+1 1/2}, . . . etc. frame.

However, interpolation along line 22, which lies along a motion vector corresponding to movement of pixels 12 in frame Fₙ, to pixels 14 Fₙ₊₁, would present the object at a more correct position at interpolated frames (e.g. as pixels 16 in interpolated frame F_{n+1/2}).

In order to interpolate along any particular motion trajectory, motion vectors for individual pixels (or groups of pixels) may be computed. Motion vectors may be computed by analyzing source or original frames to identify objects in motion. A vector is then assigned to pixels of a current frame Fₙ, if the same pixels can be located in the next frame Fₙ₊₁.

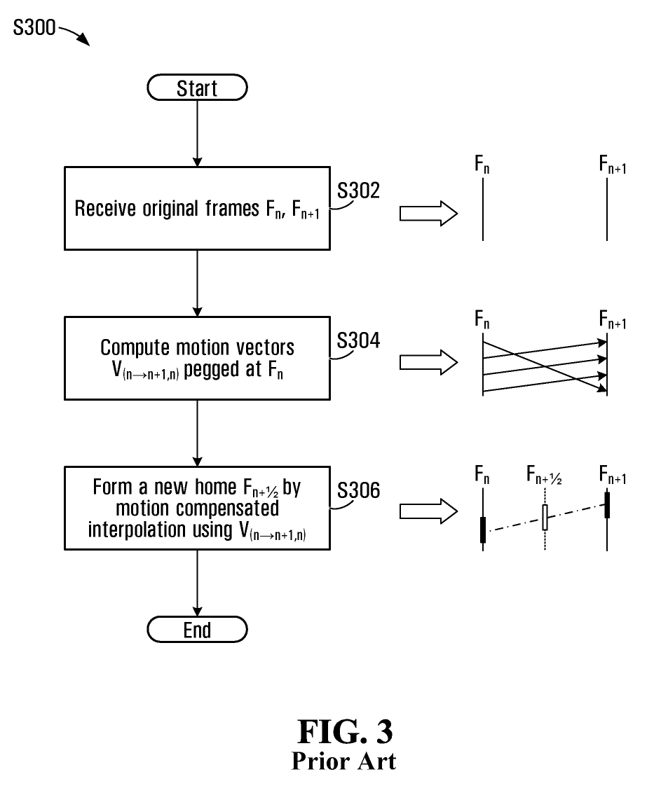

FIG. 3 illustrates a flowchart S300 which summarizes a conventional method for motion compensated interpolation of frame F_{n+1/2}. Flowchart S300 summarizes the conventional method in a manner that can be easily contrasted with methods exemplary of embodiments of the present invention that will be detailed later.

As shown in step S302, a conventional video device receives source frames Fₙ and Fₙ₊₁. In step S304, motion vectors are computed pegged at Fₙ. In other words, pixel group matching is performed on pixels or groups of pixels in Fₙ₊₁, relative to pixel groups in frame Fₙ, in order to compute motion vectors V_{{n→n+1,n}}. For each group in Fₙ, all possible candidate vectors that map it to another group in Fₙ₊₁ are evaluated, and the most likely vector is selected as a motion vector for the group.

In step S306, a new frame F_{n+1/2} is interpolated using vectors V_{{n→n+1,n}} for motion compensated interpolation. In step S306, boundaries of moving objects may be estimated by analyzing vectors V_{{n→n+1,n}} and attempts may be made to reduce artifacts during interpolation.

In motion compensated devices, motion estimation is performed by analyzing successive frames to identify objects that are in motion. The motion of each object is then described by a motion vector. A motion vector is thus characterized by length or magnitude parameter, and a direction parameter. Once motion vectors are computed, they are then assigned to every pixel in a frame, forming a corresponding vector field. Finally, interpolation of pixels proceeds by deflecting the motion trajectory using associated vectors.

Possible (or candidate) motion vectors may, for example, be determined using phase plane correlation, as for example described in Biswas, M.; Nguyen, T., A Novel Motion Estimation Algorithm Using Phase Plane Correlation for Frame Rate Conversion, Signals, Systems and Computers, 2002. Conference Record of the Thirty-Sixth Asilomar Conference on Volume 1, Issue, 3-6 Nov. 2002 Page(s): 492-496 vol.1. Motion vectors can similarly be computed, for example by block matching, hierarchical spatial correlation, gradient methods or the like.

For example, to compute motion vectors using block matching, a frame is divided into non-overlapping blocks (groups of pixels). A given group of pixels (e.g. in Fₙ) is then compared to an equally sized group of pixels (a search group) in the next frame (e.g. Fₙ₊₁), starting at the same location. The comparison is performed on a pixel by pixel basis or group of pixel by group of pixel basis. The search group is moved to all possible locations in the next frame, and the correlation of groups of pixels in Fₙ to groups of pixels in Fₙ₊₁ is determined. Correlated groups in Fₙ and Fₙ₊₁ define possible (or candidate) vectors for Fₙ.

Once candidate vectors are formed, a subset of these vectors may be selected and ultimately assigned, as motion vectors to individual pixels or groups of pixels in Fₙ depending on the confidence level established for the candidate vectors.

The groups of pixels used to determine candidate vectors need not be the same as the groups of pixels for which vectors are assigned. Pixels may be grouped in any number of ways—for example by edge detecting objects; using defined blocks; or otherwise in manners understood by those of ordinary skill.

Motion vectors are typically pegged at Fₙ—that is, each candidate vector may be evaluated for selection as a motion vector, for a group of pixels in Fₙ. Candidate vectors may map the source pixels, to corresponding destination pixels in Fₙ₊₁. If there is a high degree of correlation between source pixels in Fₙ and destination pixels Fₙ₊₁, then the candidate vector may be selected as a motion vector for the source pixels.

Motion vector computation, which attempts to match groups of pixels in Fₙ and Fₙ₊₁, is complicated by the presence of background pixels which are revealed or uncovered in Fₙ₊₁ when a foreground object moves. Such pixels which would not match any group of pixels in Fₙ. Similarly, other pixels visible in Fₙ would be hidden or covered, in the subsequent frame Fₙ₊₁ as foreground objects move to cover them.

Such pixels, called occlusion regions, create difficulties during interpolation. Moreover, multiple candidate vectors may exist for pixels in Fₙ, of which one must be chosen using some performance criteria.

Unfortunately, the movement of an object from frame Fₙ to Fₙ₊₁ can be difficult or computationally intensive to compute accurately. Thus, accurate determination of motion vectors describing the movement of objects from one frame to another, such as the motion vector describing the movement of pixels 12 to pixels 14 in FIG. 2, may be too difficult to compute efficiently.

Inaccurate motion estimation, or failure to take occlusion regions sufficiently into account, often leads to a halo artifact in which pixels surrounding boundaries of objects in an image are visibly impaired. This is highly undesirable and mitigating the halo artifact is a primary challenge for motion compensated frame rate conversion.

To mitigate the halo artifacts, object boundaries, where the effect is typically pronounced, may be found. Edges, and hence occlusion regions, can be identified by performing edge analysis using the motion vectors. Discontinuities in the motion vector field indicate the presents of edges. For example, to detect a horizontal edge in a group B, the vector difference of displacement motion vectors corresponding to groups to the right, and to the left of group B, may be computed and compared to a threshold value. Conversely, to detect a vertical edge in group B, the vector difference of displacement vectors corresponding to groups above and below group B can be computed and compared to a threshold value. The magnitudes of the vertical and horizontal difference vectors noted above are roughly commensurate with the height and width respectively, of a corresponding region around group B, exhibiting a halo artifact.

The motion vector at the edge would be the same as that associated with the foreground object. Once the occlusion regions are identified using edge detection, various interpolation strategies are possible. For example, motion compensated averaging may be used, or alternately, median values may be used for occlusion regions while motion compensated averaging may used for non-occlusion areas. Detailed discussions of the edge detection techniques and various interpolation approaches are described for example, in A. Pelaggotti and G. de Haan, High Quality Picture Rate Up-conversion for Video on TV and PC, Phillips Research Laboratories, and also in Mark J. W. Mertens and G. de Haan, A Block-Based Motion Estimator Capable Of Handling Occlusions, Philips research labs, Eindhoven, the contents of both of which are incorporated herein by reference.

It is instructive to note that conventional methods use motion vectors that are pegged at an original frame (i.e., vectors V_{{n→n+1n}} formed relative to groups of pixels within Fₙ as shown FIG. 3). However, halo artifacts may be mitigated by first forming different set of motion vectors, pegged at a different time instant, as detailed below using exemplary embodiments of the present invention.

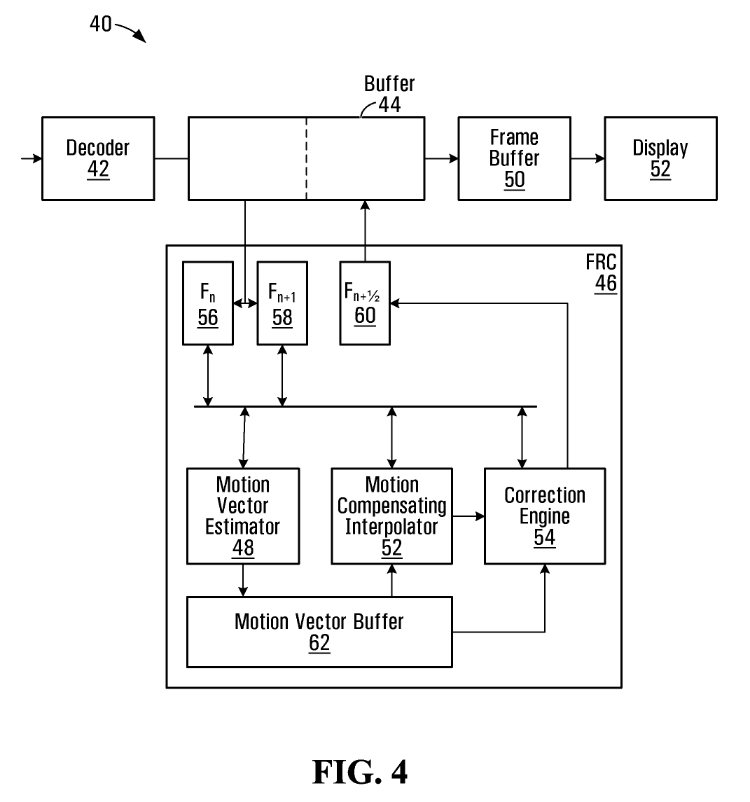

Accordingly, FIG. 4 illustrates a video device, exemplary of the present invention, which interpolates new frames during frame rate conversion, using an improved method which in which a different set of motion vectors are computed, to reduce halo artifacts in the interpolated frame.

Video device 40 includes a frame rate converter 46, exemplary of an embodiment of the present invention. As illustrated, device 40 includes a video decoder 42 that receives a video signal, in the form of a stream of digital video such as an MPEG 2, MPEG 4, H264 or other digital video stream, an analog video signal, or a signal received via a video interface (such as a DVI, HDMI, VGA, or similar). Video decoder 42 may also include a de-interlacer to produce frames from received fields. Video decoder 42 decodes the received video stream or signal and provides a stream of decoded pixels forming frames of decoded video to buffer 44. Video decoder 42 may similarly output a decoded/de-multiplexed audio stream for further processing. The audio stream is typically synchronized with output video frames. Further processing of the decoded/de-multiplexed audio stream is not detailed herein.

Video device 40 may take the form of a set top box, satellite receiver, terrestrial broadcast receiver, media player (e.g. DVD player), media receiver, or the like. Device 40 may optionally be integrated into a display device, such as a flat panel television, computer monitor, portable television, or the like. Device 40 may be formed in custom hardware, or a combination of custom hardware and general purpose computing hardware under software control.

Buffer 44 may be a first in first out (FIFO) buffer that stores several frames of video. A frame rate converter 46 is in communication with buffer 44 and extracts frames therefrom in order to produce interpolated frames to be ultimately presented on an interconnected display 52. In the depicted embodiment, frame rate converter 46 stores frames for presentation of display 52 in frame buffer 50. A display interface (not specifically illustrated) samples frame buffer 50 to present images for display. The display interface may take the form of a conventional random access memory digital to analog converter (RAMDAC), a single ended or differential transmitter conforming to the HDMI or DVI standard, or any other suitable interface that converts data in frame buffer 50 for presentation in analog or digital form on display 52. As will be appreciated, frame buffer 50 is optional and video may be output directly by frame rate converter 46.

Functional blocks of device 40 (including video decoder 42 and frame rate converter 46) may be formed as integrated circuits using conventional VLSI design techniques and tools known to those of ordinary skill.

Frame rate converter 46 may further include optional internal buffers 56, 58 to store a received sequential source frames, and another buffer 60 in which an interpolated frames are formed. Alternately, frame rate converter 46 may operate directly on buffer 44, in lieu of some or all of internal buffers 56, 58 and 60.

Frame rate converter 46 includes a motion vector estimator 48, a motion vector buffer 62, an interpolator 52 and a correction engine 54. Interpolator 52 is a motion compensating interpolator. Further, a frequency scaling factor, a clock signal and other input signals (not shown) for deriving the resulting output, may be provided to interpolator 52 and correction engine 54.

For notational clarity, as described herein, buffered original frames (e.g. decoded frames output by video decoder 42) are denoted as Fₙ, Fₙ₊₁, Fₙ₊₂, . . . etc., with subscripts signifying time instants at which the frames appear. Similarly, interpolated frames are denoted as F_{n+1/2}, F_{n+1 1/2}, . . . etc. Accordingly, a single interpolated frame temporally midway between frames Fₙ and Fₙ₊₁ is denoted by F_{n+1/2}. If two frames were to be interpolated between frames Fₙ and Fₙ₊₁ they would be denoted by F_{n+1/2} and F_{n+1/2}—again the subscripts signifying the time instant at which they appear. In addition motion vectors from Fₙ to Fₙ₊₁ pegged Fₙ at are denoted V_{{n→n+1,n}} while vectors from Fₙ to Fₙ₊₁ pegged F_{n+1/2} at are denoted V_{{n→n+1,n+1/2}}.

Internal buffers 56 and 58 may store original decoded frames that may be used to form interpolated frames by interpolator 52. Interpolator 52 is in communication with motion vector estimator 48 which provides motion vectors for use by interpolator 52. Correction engine 54 is in communication with interpolator 52 and performs halo artifact corrections on newly formed interpolated frames to be stored in buffer 60.

In operation, buffer 44 receives decoded frames Fₙ, Fₙ₊₁, Fₙ₊₂, . . . etc from decoder 42. Frame rate converter 46 may read decoded frames (e.g., Fₙ, Fₙ₊₁) into buffers 56, 58 respectively for use by motion vector estimator 48 and interpolator 52. Motion vector estimator 48 may be capable of estimating and providing motion vectors. Motion vector estimator 48 may use frames stored in buffers 56, 58 as inputs to estimate motion vectors using any of the techniques described, and place the estimated vectors in motion vector buffer 62. Interpolator 52 and correction engine 54 may read estimated motion vectors from motion vector buffer 62, as needed. Of course, in alternate embodiments, motion vector buffer 62 may be integrated into other modules (e.g., interpolator 52 or motion vector estimator 48) or may be removed entirely from frame rate converter 46.

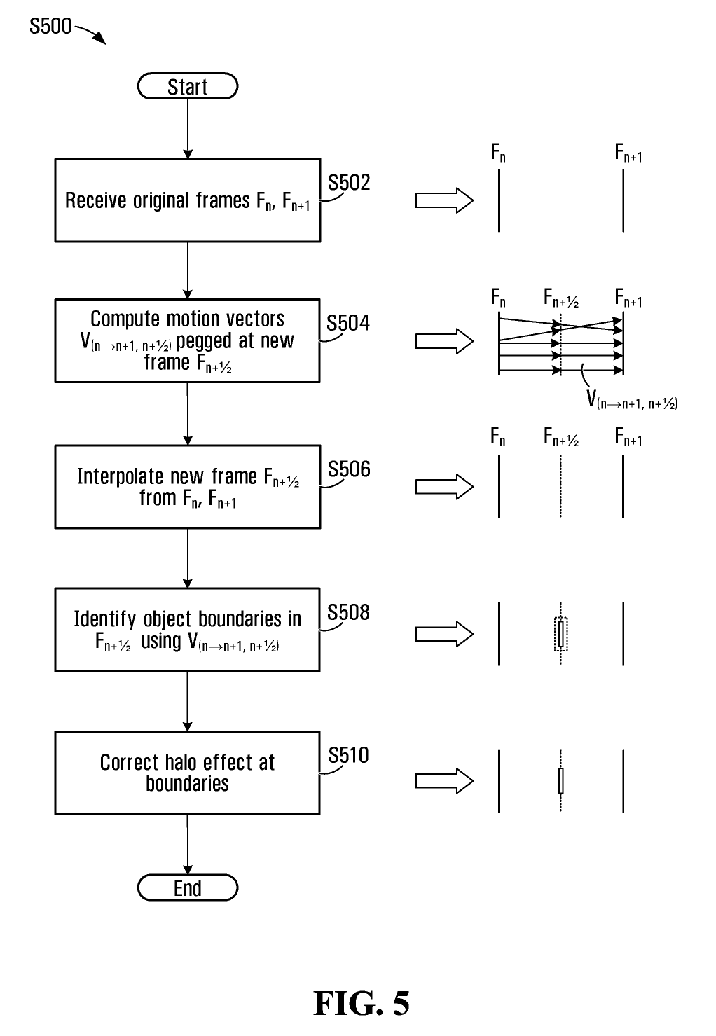

FIG. 5 illustrates a flowchart S500 of an exemplary operation of the video device 40 of FIG. 4. In step S502 video device 40 receives decoded original frames Fₙ and Fₙ₊₁ from decoder 42. Received frames Fₙ and Fₙ₊₁ may be stored in buffers 56, 58 respectively.

In step S504 motion vectors are formed pegged at F_{n+1/2} using motion vector estimator 48. Motion compensation and related interpolation techniques are generally discussed in Keith Jack, Video Demystified (A handbook for the Digital Engineer), 4th ed., Elsevier, 2005, and in John Watkinson, “The Engineer's Guide to Motion Compensation”, Snell and Wilcox Handbook Series (http://www.snellwilcox.com/community/knowledge_center/engineering_guide s/emotion.pdf), and in John Watkinson, “The Engineer's Guide to Standards Conversion”, Snell and Wilcox Handbook Series, (http://www.snellwilcox.com/community/knowledge_center/engineering_guide s/estandard.pdf), the contents of all of which are hereby incorporated by reference.

The computation of motion vectors in S504 initially involves the creation of candidate vectors using one of many techniques enumerated above. For example, the phase plane correlation technique is described in “The Engineer's Guide to Motion Compensation” referred to just above. In addition, the use of a 3D recursive block search matcher is described in Mark J. W. Mertens and G. de Haan, A Motion Vector Field Improvement for Picture Rate Conversion with Reduced Halo, Philips Research Labs, Video Processing and Visual Perception group, Prof. Holstlaan 4, Eindhoven, Netherlands, the contents of which are hereby incorporated by reference.

Candidate vectors correspond to possible motion trajectories of pixels or groups of pixels from Fₙ to Fₙ₊₁. Candidate vectors, however, only indicate a possible direction of motion within the frame—and have neither a fixed start position in Fₙ nor a fixed end position in Fₙ₊₁.

In exemplary embodiments of the present invention, motion vectors are selected pegged at a frame to be interpolated between Fₙ and Fₙ₊₁, for example at F_{n+1/2}. In other words, for a given window or group of pixel positions in F_{n+1/2}, each candidate vector is placed or arranged so that it passes through the window. The candidate vector, so placed, may map a group of source pixels in Fₙ to a corresponding group of destination pixels in Fₙ₊₁. In other words, the motion trajectory of a candidate vector may traverse a source pixel in Fₙ and a destination pixel in Fₙ₊₁. However, for some other candidate vector, the motion trajectory may traverse a group in Fₙ only, or a group in Fₙ₊₁ only, or none at all.

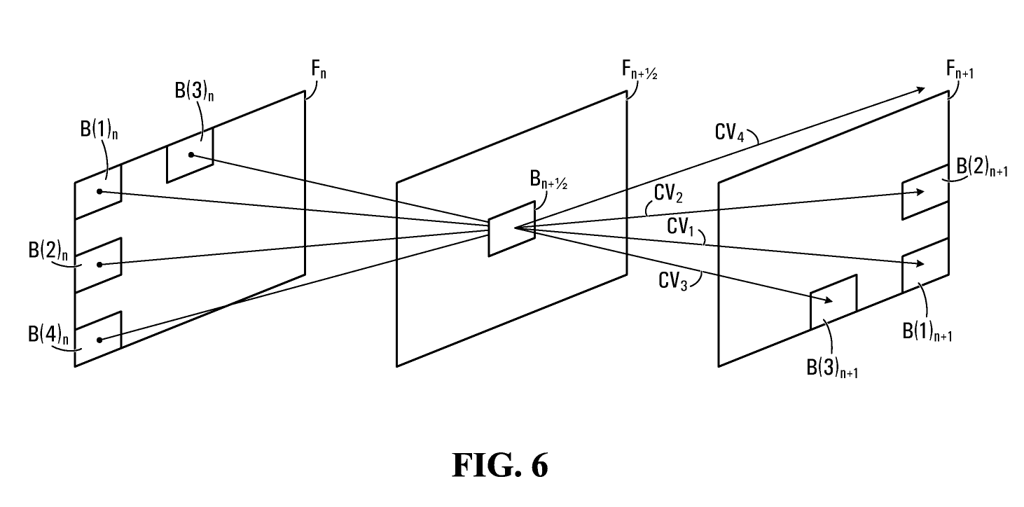

FIG. 6 depicts motion compensated interpolation exemplary of the present invention. In step S504, candidate vectors are evaluated for groups of pixels in F_{n+1/2}. As will be appreciated, pixel values in F_{n+1/2} are yet to be determined. Thus pixel groups in F_{n+1/2} are formed as groups of pixel locations, or windows of pixel positions, that have not been assigned pixel values. Pixel groups in F_{n+1/2} may for example be determined using a fixed block size (e.g. 8×8 pixel positions) or other methods that will be readily apparent to those of ordinary skill in the art.

When motion vectors are selected pegged at F_{n+1/2}, each candidate vector for a given group of pixels B_{n+1/2} in F_{n+1/2} is arranged or placed, so as to pass through B_{n+1/2} as shown in FIG. 6. It should be noted that the candidate vectors are already determined as noted above.

Now, when placed so as to pass through B_{n+1/2}, a candidate vector may map or connect a group of pixels in Fₙ to another group in Fₙ₊₁. For example, candidate vectors cv₁ ,cv₂, and cv₃ in FIG. 6 map groups B(1)ₙ, B(2)ₙ and B(3)ₙ in Fₙ, to a corresponding groups B(1)ₙ₊₁, B(2)ₙ₊₁ and B(3)ₙ₊₁ in Fₙ₊₁ respectively. However, the motion trajectory of another candidate vector may traverse a pixel group in Fₙ only, or a group of pixels in Fₙ₊₁ only, or none at all. For example, candidate vector cv₄ only traverses B(4)ₙ in Fₙ in FIG. 6.

As will now be appreciated, for a given group of pixel locations in F_{n+1/2} the correlation test is performed between a pair of corresponding groups in Fₙ and Fₙ₊₁ indicated by the motion trajectory of a candidate vector. A sufficiently high correlation allows a candidate vector to be selected as a motion vector. Thus, for B_{n+1/2}, candidate vector cv₁ may be evaluated on the basis of the correlation between B(1)ₙ and B(1)ₙ₊₁; while candidate vector cv₂ may be evaluated on the basis of the correlation between B(2)ₙ and B(2)ₙ₊₁ and so on. The candidate vector that provides the best correlation may be selected as a motion vector.

When motion vectors are selected pegged at F_{n+1/2}, for a given group B_{n+1/2} in F_{n+1/2} each candidate vector is first placed so that it passes through B_{n+1/2}, and then evaluated for selection using some criteria.

As may be appreciated, for a set of K candidate vectors (e.g. cv₁, cv₂, . . . , cv_{K}) through B_{n+1/2}, there may be up to K correlation tests, between groups of pixels. In the example shown in FIG. 6, for each of vectors cv₁,cv₂, cv₃ connects one of many groups of pixels in Fₙ (i.e., one of B(1)ₙ, B(2)ₙ and B(3)ₙ) to a corresponding group of pixels in Fₙ₊₁ (i.e., B(1)ₙ₊₁, B(2)ₙ₊₁ and B(3)ₙ₊₁ respectively). One of candidate vectors cv₁, cv₂, cv₃, cv₄ may thus be selected as the motion vector, if it is established that it offers the required confidence level based on the confidence criteria (e.g., the correlation corresponding source and destination groups of pixels).

A candidate vector like candidate vector cv₄ may be indicative of the trajectory for the trailing edge of a foreground object in motion, represented by B(4)ₙ and B_{n+1/2}, that becomes completely obscured by the background in Fₙ₊₁.

In some cases, a candidate vector passing through a pixel in B_{n+1/2} may map a partial pixel in Fₙ to a partial pixel Fₙ₊₁. In other words, the motion trajectory of a candidate vector passing fully through a pixel position (at integral integer coordinates of a grid pixel locations in F_{n+1/2}) in B_{n+1/2} may traverse non-integer coordinates in Fₙ and Fₙ₊₁.

More generally, motion vectors may be selected pegged at any frame Fₚ between Fₙ and Fₙ₊₁—where Fₚ corresponds to an interpolated frame at time instant p (for n<p<n+1). Motion vectors evaluated and selected, relative to time instant p are denoted V_{{n→n+1,p}} for convenience. Accordingly, candidate vectors selected as motion vectors relative to time instant n+½ are denoted V_{{n→n+1, n+1/2}}.

The resulting set of all selected candidate vectors pegged at F_{n+1/2} is the set of motion vectors denoted V_{{n→n+1,n+1/2}}. Motion vector estimator 48 may provide these motion vectors V_{{n→n+1,n+1/2}} by placing them in motion vector buffer 62.

In step S506, a new frame F_{n+1/2} is interpolated by interpolator 52 using frames Fₙ and Fₙ₊₁ in buffers 56, 58 and motion vectors V_{{n→n+1,n+1/2}} stored in motion vector buffer 62.

Interpolation of a pixel in B_{n+1/2} using a motion vector cvᵢ which maps or connects B(i)ₙ to B(i)ₙ₊₁ may include, selecting a pixel in B(i)ₙ, selecting a pixel in B(i)ₙ₊₁, averaging corresponding pixels in B(i)ₙ and B(i)ₙ₊₁, median filtering corresponding pixels in B(i)ₙ and B(i)ₙ₊₁ with other pixels, or employing any one of a number of other interpolation techniques that are well known to those of ordinary skill in the art. The newly formed frame F_{n+1/2} may be stored in buffer 60.

As noted, motion vector estimators such as estimator 48 may use phase plane correlation, block matching, hierarchical spatial correlation, gradient methods or phase correlation or the like to generate motion vectors.

For clarity, the operation of an exemplary embodiment of the present invention has been described using two original frames. However, it should be understood that more than two frames may be used during motion estimation by motion estimator 48. In addition, previously interpolated output frames, or other data such as segmentation information, and video encoding related data may also be used to aid in motion estimation and interpolation.

In step S508, boundaries of objects are estimated by analyzing vectors V_{{n→n+1,n+1/2}} formed in step S504 as described. The magnitudes of the vertical and horizontal difference vectors, formed to identify or detect edges as noted above, provide an estimate of width and height respectively, of regions likely to exhibit a halo artifact.

Finally in step S510, correction engine 54 is used to correct halo artifacts that may be found at the boundaries of objects in interpolated frame F_{n+1/2}. Having estimated regions of halo artifacts around edges, as noted above, the halo artifacts may be corrected for example, by spatial filtering the region by way of a low-pass filter or a median filter employed in correction engine 54. The filtering may alternately be preformed using bilateral filtering techniques as disclosed for example in C. Tomasi and R. Manduchi, “Bilateral filtering for gray and color images,” Proceedings of IEEE Int. Conf. on Computer Vision, 1998, pp. 836-846. Bilateral filtering techniques smooth images while preserving edges, by performing nonlinear combinations of nearby image values. Various other ways of filtering to mitigate halo artifacts will be known to those of ordinary skill in the art.

It will be readily understood by those skilled in the art, that although only one interpolated frame is shown between two original frames in the depicted exemplary embodiment, in other embodiments, two, three or more newly interpolated frames may be formed between any two original frames, using the exemplary method and device described herein.

The circuits and methods described herein are not restricted to the interpolation of frames, but rather they are also applicable to the interpolation of fields. The embodiments described may be used to receive original fields from an interlaced video sequence, and interpolate new fields.

Of course, the above described embodiments, are intended to be illustrative only and in no way limiting. The described embodiments of carrying out the invention, are susceptible to many modifications of form, arrangement of parts, details and order of operation. The invention, rather, is intended to encompass all such modification within its scope, as defined by the claims.

What is claimed is:

1. A method of video frame rate conversion comprising:
i) forming candidate vectors, each of said candidate vectors connecting a group of pixels in a frame Fₙ to a corresponding group of pixels in another frame Fₙ₊₁;
ii) forming a set of motion vectors by forming groups of pixel locations in an intermediate frame Fₚ; and for each one of said groups of pixel locations Bₚ in Fₚ, selecting a motion vector from said candidate vectors each arranged to pass through Bₚ;
iii) interpolating pixel values of said pixel locations in Bₚ from at least one of a first and second group of pixels in Fₙ and Fₙ₊₁ respectively, connected by said selected motion vector;
iv) identifying regions of halo artifacts in said intermediate frame Fₚ using said set of motion vectors and filtering said regions to reduce said halo artifacts.

2. The method of claim 1, wherein said forming said candidate vectors comprises using one of phase plane correlation, block matching, hierarchical spatial correlation, and gradient methods.

3. The method of claim 1, wherein said motion vector is selected if a sufficiently high correlation is established between said first and second groups of pixels, connected by said motion vector.

4. The method of claim 1, wherein said filtering comprises one of median filtering, low-pass filtering and bilateral filtering.

5. The method of claim 1, wherein said interpolating comprises selecting a pixel from said first group of pixels in Fₙ.

6. The method of claim 1, wherein said interpolating comprises selecting a pixel from said second group of pixels in Fₙ₊₁.

7. The method of claim 1, wherein said interpolating comprises averaging corresponding pixels from said first and second groups of pixels in Fₙ and Fₙ₊₁ respectively.

8. The method of claim 1, wherein said interpolating comprises median filtering corresponding pixels from said first and second groups of pixels in Fₙ and Fₙ₊₁ respectively.

9. The method of claim 8, wherein said median filtering includes pixels other than said corresponding pixels from said first and second groups of pixels.

10. The method of claim 1, wherein Fₙ, Fₚ and Fₙ₊₁ correspond to time instants n, p and n+1 respectively where n<p<n+1.

11. The method of claim 10, wherein p=n+½.

12. The method of claim 1, wherein each one of said Fₙ, Fₙ₊₁ and Fₚ is a field instead of a frame.

13. The method of claim 1, wherein said identifying said regions of halo artifacts comprises edge detection in Fₚ, said detection comprising, for each Bₚ in Fₚ,
i) forming a vertical difference, of motion vectors corresponding to groups of pixels above and below Bₚ; and forming a horizontal difference, of motion vectors corresponding to groups of pixels left of and right of Bₚ;
ii) comparing said vertical and horizontal differences to corresponding thresholds and upon said differences exceeding said thresholds, providing height and width estimates for said regions commensurate with magnitudes of said vertical and horizontal differences respectively.

14. A frame rate converter circuit comprising:
i) a motion vector estimator in communication with a buffer storing original frames Fₙ and Fₙ₊₁, said estimator forming candidate vectors each connecting a group of pixels in Fₙ to a corresponding group of pixels in Fₙ₊₁; said estimator forming groups of pixel locations in a frame Fₚ to be interpolated between Fₙ and Fₙ₊₁, and forming a set of motion vectors by selecting a motion vector for each of said groups Bₚ in Fₚ from said candidate vectors each arranged to pass through Bₚ;
ii) an interpolator in communication with said estimator, for interpolating pixel values of said locations in Bₚ from at least one of a first and second group of pixels in Fₙ and Fₙ₊₁ respectively, connected by said selected motion vector; and
iii) a correction engine, for performing halo artifact correction on Fₚ using said set of motion vectors.

15. The circuit of claim 14, wherein said buffer comprises a first buffer and a second buffer for receiving frames Fₙ and Fₙ₊₁ respectively;

16. The circuit of claim 14, wherein said correction engine performs one of low-pass filtering, bilateral filtering and median filtering.

17. A video device comprising the circuit of claim 14.

18. The circuit of claim 14, wherein each of said Fₙ, Fₙ₊₁ and Fₚ is a field instead of a frame.

19. An integrated circuit comprising the circuit of claim 14.
